(19) United States
(12) Patent Application Publication
(10) Pub. No.: US 2025/0389889 A1
(43) Pub. Date: Dec. 25, 2025

(54) INTERPOSER WITH AN INTEGRATED OPTICAL WAVEGUIDE

(71) Applicants: Advanced Micro Devices, Inc., Santa Clara, CA (US); XILINX, INC., San Jose, CA (US)

(72) Inventors: Marzieh BAKHTIARY, Austin, TX (US); Hao-Hsiang LIAO, San Jose, CA (US); Suresh RAMALINGAM, Fremont, CA (US); Sri Ranga Sai BOYAPATI, Austin, TX (US)

(21) Appl. No.: 18/752,738

(22) Filed: Jun. 24, 2024

(51) Int. Cl. G02B 6/122; G02B 6/13

(52) U.S. Cl. CPC G02B 6/122; G02B 6/13

(57) ABSTRACT

Disclosed herein are an interposer, an integrated (IC) chip assembly including the interposer, and a method for making the IC chip assembly. The interposer includes a transparent core having a cavity and an optical waveguide formed in a surface of the cavity, an optical source disposed within the cavity and coupled with the optical waveguide, and a photonic integrated circuit disposed within the cavity and coupled with the optical waveguide. The photonic integrated circuit, the optical source, and the transparent core are co-planar with each other. The interposer further includes a redistribution layer disposed on the transparent core and having metal traces coupled with the optical source. The chip assembly includes an IC die stack having a plurality of IC dies and a package substrate disposed under the interposer. The interposer disposed under the IC die stack, and the interposer coupling the IC die stack with the package substrate.

### TECHNICAL FIELD

Embodiments of the present invention generally relate to a module having an integrated photonic device and an integrated circuit die stack coupled with the module, and, more particularly, relate to an interposer with an integrated optical waveguide.

### BACKGROUND

Artificial Intelligence (AI) related computing and data centers have significantly increased the demand for computing power and bandwidth for data transmission. To meet the increasing demand on processing capabilities, chip packaging schemes often form an integrated circuit (IC) die stack by vertically mounting a plurality of IC dies. The IC die stack may include IC dies for memory, logic, communication, power management, or other functions. One or more IC die stacks can be mounted on an interposer, which is mounted to a package substrate. The interposer functions as an interface between the IC die stacks and the package substrate and often needs to transmit data at a very high speed.

In a conventional interposer, electrical conductors, such as copper, aluminum, and gold, are typically used for transmitting power, control commands, data, and other signals. But, electrical conductors are not an ideal candidate for high-speed communication due to the long interconnection length, high heat generation, and high power consumption. Although optical signals can eliminate many limitations of electrical conductors, it is challenging to integrate optical devices using the existing fabrication processes and materials for an interposer.

Therefore, a need exists for an interposer capable of utilizing optical signals for data transmission at a high speed.

### SUMMARY

Disclosed herein are a module having an integrated photonic device, an integrated circuit (IC) chip assembly coupling with the module, and a method for making the IC chip assembly. In an example, the module is included the IC chip assembly as an interposer. The interposer includes a transparent core having a cavity and an optical waveguide formed in a surface of the cavity, an optical source disposed within the cavity and coupled with the optical waveguide, and a photonic integrated circuit disposed within the cavity and coupled with the optical waveguide. The photonic integrated circuit, the optical source, and the transparent core are co-planar to each other, and a redistribution layer is disposed on the transparent core and has metal traces coupled with the optical source. In another example, the module may be included in the IC chip assembly in a same tier as an IC die.

In another example, the chip assembly includes an IC die stack having a plurality of IC dies, the interposer disposed under the IC die stack, and a package substrate disposed under the interposer. The interposer couples the IC die stack with the package substrate.

In another example, a method includes making an interposer that has an optical waveguide coupled with an optical source and a photonic integrated circuit. Making the interposer includes forming a cavity within a transparent core, forming a through via in the transparent core, forming the optical waveguide within the cavity, disposing the optical source within the cavity, and disposing the photonic integrated circuit within the cavity. The method further includes mounting the interposer on a package substrate, positioning an IC die stack on the interposer, and coupling the optical waveguide of the interposer with an IC die stack of the IC chip assembly.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 illustrates a schematic cross-sectional view of an integrated circuit die assembly with an interposer, according to an embodiment of the present disclosure.

FIG. 2 illustrates a schematic cross-sectional view of an interposer having an optical device, according to an embodiment of the present disclosure.

FIG. 3 illustrates a process for fabricating an interposer by an ion-exchange method, according to an embodiment of the present disclosure.

FIG. 4 illustrates a process for fabricating an interposer with a laser writing method, according to an embodiment of the present disclosure.

FIG. 5 illustrates a schematic cross-sectional view of an interposer having an optical device, according to an embodiment of the present disclosure.

FIG. 6 illustrates a method for fabricating an integrated circuit die assembly, according to an embodiment of the present disclosure.

FIG. 7 illustrates a schematic partial cross-sectional view of an interposer, according to an embodiment of the present disclosure.

To facilitate understanding, identical reference numerals have been used, where possible, to designate identical elements that are common to the figures. It is contemplated that elements of one embodiment may be beneficially incorporated in other embodiments.

### DETAILED DESCRIPTION

In an example, the present disclosure discloses a module having an integrated photonic device and an integrated circuit (IC) die assembly having the module. The module may function as an interposer in the IC die assembly. The interposer is configured to utilize optical signals for data transmission. The interposer integrates optical devices, such as a laser emitter, an optical waveguide, and a photonic integrated circuit, in a transparent core. Redistribution layers (RDL) are disposed on the transparent core to provide fan out or fan in connections. The interposer is capable of utilizing laser signals generated by a laser device for high speed data transmission between an IC die stack and a package substrate.

In an example, the transparent core is made of glass with a high refractive index, such as between about 1.4 and about 2.4. The glass may be alkali based or non-alkali based. The transparent core has a cavity sized to contain various optical devices. In an example, an optical waveguide is formed along surfaces of the cavity and couples optical devices disposed within the cavity to an external source. The optical waveguide is formed within the surface of the cavity and has a higher refraction index than surrounding substrate materials. The optical waveguide may be formed by any suitable method, such as an ion-exchange method and a laser writing method. Redistribution layers are disposed on the transparent cores and provide electric connections between the IC die stack and the optical devices disposed in the cavity. The transparent core also includes through vias that can provide electric connections between optical devices disposed in the cavity and the package substrate.

The integration of the IC dies stack and the interposer as configured according to various embodiments of the present disclosure can reduce the electrical loss and improve power efficiency due to the decrease of the required electrical connection, especially for high channel count cases. The integration of electro-optical components such as optical waveguides, through glass vias (TGVs), and electrical redistribution layers (RDLs) with fine-line electrical routing, can also lower assembly cost. The TGVs may be formed in various shapes, such as a tubular shape, a cone shape, a combination of tubular and cone shapes, or any other suitable shape.

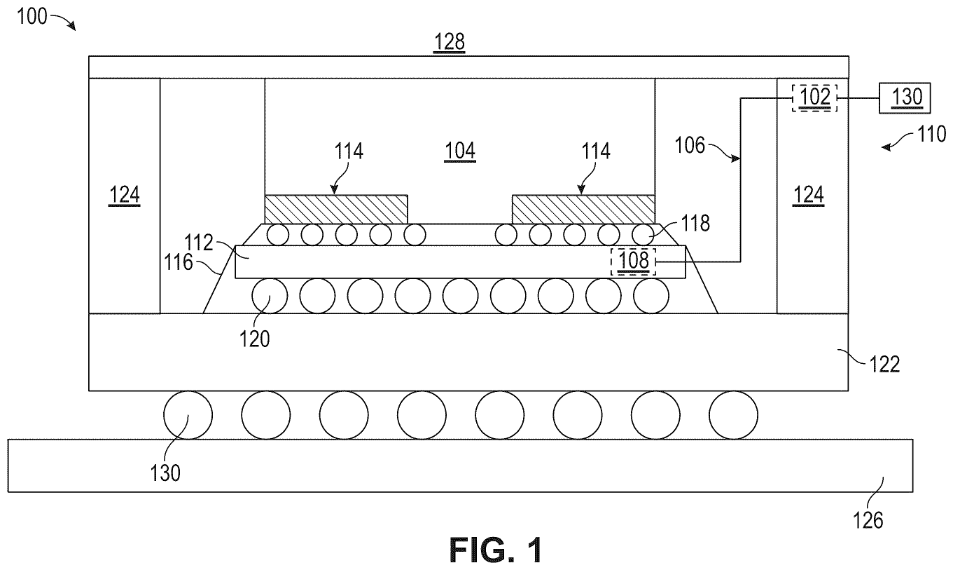

FIG. 1 illustrates a schematic cross-sectional view of an electronic device 100 including an interposer 122 having an integrated photonic device 108, according to an embodiment of the present disclosure. The electronic device 100 may be included in a tablet, computer, copier, digital camera, smart phone, control system, automated teller machine, server, a data center, an artificial intelligence (AI) engine, or other solid-state memory and/or logic device. The electronic device 100 includes a chip assembly 110 mounted on a printed circuit board (PCB) 126. The chip assembly 110 is connected with the PCB 126 via a plurality of electric connections 130, such as solder balls or other suitable connections. The electronic device 100 may include one or more PCBs 126, and the PCB 126 may include one or more chip assemblies 110. The chip assembly 110 of the electronic device 100 includes components, such as dies, interposers, or package substrates, that has an integrated photonic device as set forth in various embodiments of the present disclosure.

The chip assembly 110 includes an IC die stack 104 mounted on an interposer 112 as set forth in various embodiments of the present disclosure. IC die stack 104 includes at least one or more integrated circuit (IC) dies 114. In the example depicted in FIG. 1, the IC die stack 104 include two IC dies 114 stacked side by side on top surface of the interposer 112. Alternatively, the two IC dies 114 may be stacked one on top of the other. Additional dies, not shown, may be included in the IC die stack 104, either on top of or laterally adjacent to, an IC die 114 of the IC die stack 104.

Continuing to refer to FIG. 1, each IC die 114 of the chip package 110 includes functional circuitry. The functional circuitry may include block random access memory (BRAM), UltraRAM (URAM), digital signal processing (DSP) blocks, configurable logic elements (CLEs), and the like. The IC die 114 may be, but is not limited to, programmable logic devices, such as field programmable gate arrays (FPGA), memory devices, such as high band-width memory (HBM), optical devices, processors or other IC logic structures. The IC die 114 may optionally include optical devices such as photo-detectors, lasers, optical sources, and the like. The IC die 114 may also be configured as a processor that includes central processing unit (CPU) cores. As such, the IC die 114 may be referred to as a CPU die or CPU chiplet. The functional circuitry of the IC die 114 may also include System Management Unit (SMU). The SMU is circuitry configured to monitor thermal and power conditions and adjust power and cooling to keep the IC die 114 functioning as within specifications. The functional circuitry of the IC die 102 may also include Dynamic Function exchange (DFX) Controller IP circuitry. The DFX circuitry provides management of hardware or software trigger events. For example, the DFX circuitry may pull partial bitstreams from memory and delivers them to an internal configuration access port (ICAP). The DFX circuitry also assists with logical decoupling and startup events, customizable per Reconfigurable Partition.

In another example, the functional circuitry of IC die 114 may include accelerated compute cores. As such, the IC die 114 may be referred to as an accelerator die or accelerator chiplet. The IC die 114 may also be referred to as a graphic processing unit (GPU) die or GPU chiplet. The accelerated compute cores contained in the functional circuitry of the IC die 114 generally includes math engine circuitry. The math engine circuitry is generally designed for task specific computing, such as used data center computing, high performance computing and AI/ML computing. Along with the accelerated compute cores, functional circuitry of the IC die 114 may also include SMU circuitry and DFX circuitry. In the example of FIG. 1, the IC die 114 is a logic die having math processor (also known as math engine) circuitry for accelerating machine-learning math operations in hardware, such as self-driving cars, artificial intelligence and data-center neural-network applications.

In one example, all of the IC dies 114 within the chip package 110 are the same type. In other examples, one or more of the IC dies 114 within the chip package 110 are different types. When a plurality of IC dies 114 are utilized, the IC dies 114 may be disposed in a vertical stack and/or disposed laterally side by side. Although two IC dies 114 are shown in FIG. 1, the number of IC dies 114 disposed in the chip package 110 may vary from one to as many as can fit within the chip package 110. Additionally, one or more of the IC dies 114 may optionally be configured as a chiplet.

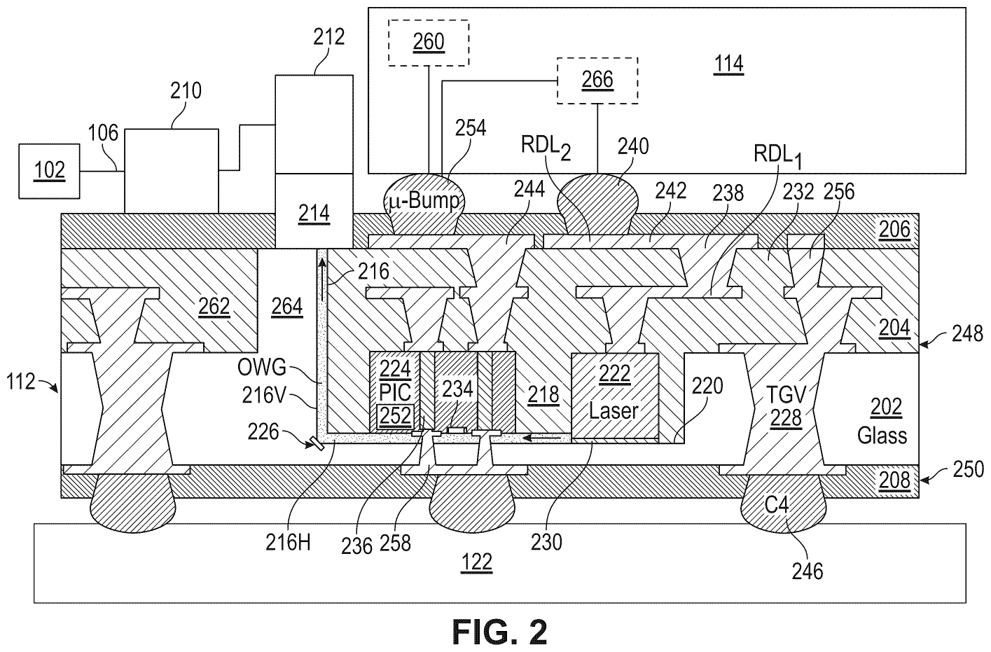

The interposer 112 couples the one or more IC dies 114 of the IC die stack 104 with a package substrate 122 and provides data communication, ground, and power transmission between the IC die stack 104 and the package substrate 122. The interposer 112 includes integrated optical devices 108, as further detailed below with reference to FIG. 2. In an embodiment, an optical interface 102 is included in the chip package 110 and is configured to provide data communication between the IC die stack 104 and an external device 130, such as a server, a controller, a memory, or other suitable electronic device. The optical interface 102 may be disposed in a stiffener 124 and couples with the integrated optical devices 108 of the interposer 112 via an optical communication channel 106. The optical interface 102 may also be disposed in other components of the chip package 110, such as the package substrate 122, a lid 128, or any other suitable components. The optical communication channel 106 may include an optical fiber array, an optical cable, or other suitable optical channel. Solder connections 120, also known as “package bumps” or “C4 bumps,” are utilized to provide an electrical connection between the interposer 112 and the package substrate 122. The interposer 112 is configured to integrate optical sources, optical waveguides, photonic integrated circuits, electronic integrated circuits, and other components. The configuration of the interposer 112 will be described in detail later in referring to other figures.

The stiffener 124 is optional and is coupled with the package substrate 122 and configured to enhance the warpage resistance of the package substrate 122 against out of plane deformation. The optical interface 102 may be coupled with the stiffener 124. The chip assembly 110 further includes an optional lid 128. The lid 128 is configured to cover the IC die stack 104 and dissipate heat generated by the chip assembly 110. The lid 128 may include active and/or passive heat transfer devices, such as vapor chambers, heat pipes, phase change materials, fins, fans, force fluid heat exchangers, thermoelectric devices, and the like.

The IC die stack 104 is mounted to a top surface of the interposer 112 by die connections 118. The die connections 118 may be in the form of a plurality of solder joints, also known as “micro-bumps.” An under molding 116 may be utilized to fill the space not taken by the solder connections 120 between the interposer 112 and the package substrate 122. A gap fill material may be utilized to fill gaps within the IC die stack 104 such as the gap between the IC dies 114.

FIG. 2 illustrates a schematic partial cross-sectional view of an interposer 112, according to an embodiment of the present disclosure. The interposers 112 couples with the IC dies 114, the package substrate 122, and the optical interface 102. The functions of the interposer 112 include transmitting data among the functional circuits 260 of the IC dies 114 (only one is shown in FIG. 2) and the package substrate 122 and transmitting data among the functional circuits 260 and the optical interface 102.

The interposer 112 includes a transparent core 202, a redistribution layer 204 disposed on an upper surface of 248 the transparent core 202, a top dielectric layer 206 disposed on the redistribution layer 204, and a bottom dielectric layer 208 disposed on a bottom surface 250 of the transparent core 202. The transparent core 202 includes a cavity 218 that is configured to contain one or more photonic devices, such as a photonic integrated circuit 224 and an optical source 222. The transparent core 202 may include one or more additional cavities, such as a second cavity 262. The second cavity 262 may also be configured to contain one or more photonic devices. The cavities 218, 262 are separated by a wall 264.

In an example, an optical waveguide 216 is formed in the cavity 218 of the transparent core 202. The optical waveguide 216 is configured to transmit optical signals from an optical source 222 to a first optical interface 210. A PIC 224 couples with the optical waveguide 216 and is configured to process the optical signals in the optical waveguide 216. The first optical interface 210 may be disposed on the interposer 112 and include a fiber connector having an array of optical fibers. The optical interface 210 may couple with an array of lenses 212 dedicated for the array of the optical fibers. The lenses 212 are paired with a waveguide lens 214 mounted on the interposer 112 and disposed at an end of the optical waveguide 216. The first optical interface 210 is coupled with a second optical interface 102 (also shown in FIG. 2) via the optical communication channel 106. Again, the second optical interface 102 transmits optical signals to an external device 130 (shown in FIG. 1). In an embodiment, the PIC 224 and the optical source 222 are coupled to a controller 266 disposed in the die 114. The controller 266 is configured to control the optical source 222 and the PIC 224 to transmit data from the die 114 to the optical interface 102 via the optical waveguide 216. The controller 266 causes the optical source 22 to generate optical signals and cause the PIC 224 to further process the optical signals, such as modulating, amplifying, or phase-shifting.

The transparent core 202 has a high refractive index ranging from about 1.4 to about 2.4. The transparent core 202 may be made of glass or any other suitable transparent material. The cavity 218 sized to contain a plurality of optical devices, such as the optical source 222, and/or electrical devices, such as the photonic integrated circuit (PIC) 224. In an embodiment, the refractive index of the transparent core 202 at predetermined locations can be increased by various processes, such as an ion exchange process or a laser writing process, thus allowing the formation of an optical waveguide of various patterns within the transparent core 202. For example, the optical waveguide 216 is formed in the transparent core 202 that extends between the waveguide lens 214 and the optical source 222. In an embodiment, the waveguide 216 is formed within the transparent core 202 and extends from the surface 220 into the transparent core 202 at a predetermined depth, which may also be referred to as a thickness of the waveguide 216.

In an embodiment, the optical waveguide 216 may have a thickness no greater than 20 μm, no greater than 10 μm, or no greater than 5 μm. The optical waveguide 216 may include a horizontal segment 216H and a vertical segment 216V. The horizontal segment 216H is disposed along a horizontal surface of the cavity 218. The vertical segment 216V is disposed along a vertical surface of the separation wall 264 of the transparent core 202 and extends to the bottom surface of the top dielectric layer 206 so that the optical waveguide 216 can be coupled with the lens 214 disposed on the surface of the interposer 112. The separation wall 264 separates the two cavities 218 and 262. In an embodiment, an optical mirror 226 is disposed at a joining location between the vertical segment 216V and the horizontal segment 216H. The waveguide 216 is configured to transmit optical signals emitted by the optical source 222 to the PIC 224, and then to the waveguide lens 214.

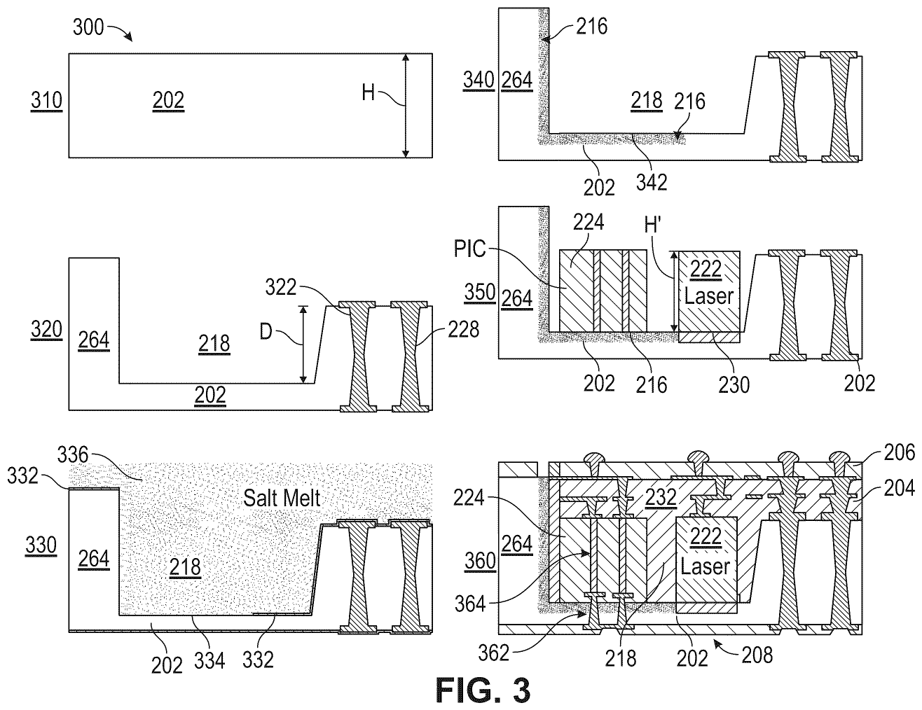

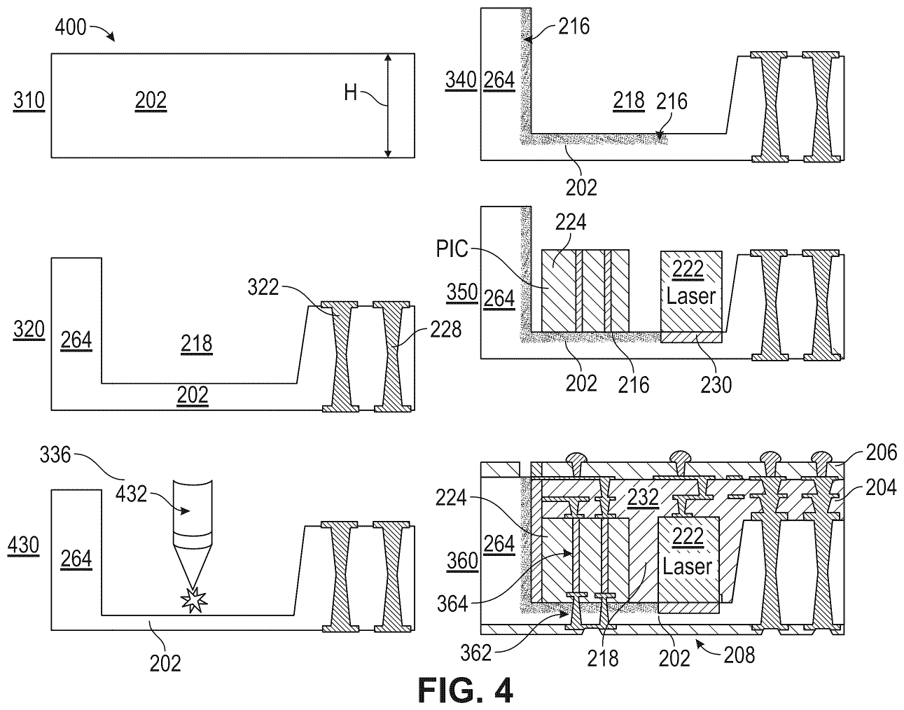

The cavities 218 and 262 are sized to contain a plurality of types of devices, such as functional circuitries, IC chips, or any other suitable device. In the example shown in FIG. 2, the cavity 218 contains the optical source 222 and a PIC 224. The optical source 222 may include a laser emitter or any other suitable optical emitters. The optical source 222 is attached to the surface 220 via an adhesion film 230. In an embodiment, the adhesion film 230 has a refractive index matched with the optical waveguide 216, and the optical source 222 is attached to the optical waveguide 216 via the adhesion film 230. In another embodiment, the adhesion film 230 may have a refractive index not matched with the optical waveguide 216. In this situation, a portion of the bottom surface of the optical source 222 is attached to the surface 220 via the adhesion film 230, while the other portion of the bottom surface of the optical source 222 couples directly with the waveguide 216 such that optical signals, such as laser, emitted by the optical source 222 can enter the waveguide 216 directly. The optical source 222 can be configured to emit laser via a bottom surface or a side surface, and the waveguide 216 may extend to the side surface of the optical source (shown in FIG. 2) or may extend underneath and overlap with the bottom surface of the optical source 222 (shown in FIGS. 3 and 4). The optical source 222 may include a course wavelength division multiplexing (CWDM) edge emitting laser, an O-band distributed feedback (DFB) laser, or any other suitable laser.

The PIC 224 is coupled with the optical waveguide 216 and includes a plurality of electric-photonic components configured to implement active or passive functions for processing optical signals. The PIC 224 may include integrated photonic components for detecting, generating, guiding, modulating, phase-shifting, amplifying, or polarizing optical signals. In an example, the PIC 224 is a silicon based solid state device and includes a photonic component 234 configured to couple with the optical waveguide 216 and process the optical signals in the optical waveguide 216. The photonic component 234 may be an emitter, a photodetector, an amplifier, a modulator, a waveguide, a phase-shifter, or another other suitable photonic component. The PIC 224 may further include electrical vias 236 and functional circuitries 252 that are configured to transmit data and power with the package substrate 122.

The PIC 224 and the optical source 222 are substantially co-planar with the cavity 218. In an example, the PIC 224 and the optical source 222 may have a height of about 300 μm, which is substantially the same as the depth of the cavity 218.

The redistribution layer 204 is formed by multiples layers of dielectric material 232 embedded with a plurality of metal traces, formed from lines, vias, and contact pads. The dielectric material 232 may be a polymer based material, such as Ajinomoto Build-up Film (ABF), cyclotene, parylenes, or any other suitable material. In an embodiment, the redistribution layer 204 includes at least two metal layers, shown as RDL₁ and RDL₂. The redistribution layer 204 may have a greater number of metal layers, such as three, four, or ever a greater number of metal layers. The optical source 222 is coupled to an electrical connection 240 via a plurality of metal traces 238 for receiving power, ground and control signals. The plurality of metal traces 238 include a pad 242 formed in the RDL₂ disposed on the surface of one of the dielectric layers of the redistribution layer 206. In an embodiment, the pad 242 may be larger than other pads of the RDL₂ that are coupled to objects other than the optical power source 222 (the PIC 224, as an examples), such as double or triple the size of other pads, so that the pad 242 functions as a heat sink for removing heat from the optical source 222. A plurality of metal traces 244 couple the PIC 224 with an electrical connection 254 for receiving power, ground, data, and control signals. The electrical connections 254 and 240 may include u-bump, hybrid bump, or any other suitable connection.

In an embodiment, the transparent core 202 also includes a plurality of through glass vias 228 (TGV) coupled with metal traces 256 in the redistribution layer 204. The top dielectric layer covers the redistribution layer 204 and the transparent core 202. The electric connections 240, 254 are disposed in the top dielectric layer 206. In addition, the bottom dielectric layer covers the transparent core 202 and includes a plurality of electric connections 246 coupled with the TGV 228 and other metal traces 256 in the transparent core 202. The electric connection 246 may include a C4 bump. The TGV 228 and the metal traces 256, as well as backside via 258, PIC vias 236, and metal traces 244, provide electrical connections between the IC die stack 104 and the package substrate 122.

FIG. 3 illustrates a process 300 for making an interposer with integrated optical devices, according to an embodiment of the present disclosure. At operation 310, a transparent core 202 is prepared by polishing and cutting to a proper size. In an embodiment, the transparent core 202 has a high refractive index in the range of about 1.4 to about 2.4. A thickness H of the transparent core is no greater than 500 μm, or no greater than 400 μm or no greater than 350 μm. The transparent core 202 may include an alkali-base glass substrate.

At operation 320, a cavity 218 is formed in the transparent core 202. The cavity may have a depth D ranging between about 300 μm to about 400 μm. A plurality of through holes 322 are formed in a wall surrounding the cavity 218 by etching, drilling, or any other suitable method. TGVs 228 are formed in the through vias 322 by plating a metal or other suitable method.

At operation 330, an ion exchange process is implemented. A mask layer 332 is first disposed on the transparent core 202. The mask layer 332 forms a pattern of the optical waveguide 216. For example, the mask layer 332 blocks certain areas from an ion exchange and exposes certain areas 334 for an ion exchange. The unblocked areas 334 are exposed to exchange ions in the transparent core 202 with a molten salt source 336 to increase the refractive index. The mask layer 332 may be a metal layer, such as aluminum, a polymer layer, such as a photoresist, or any other suitable material. The mask layer 332 may be formed on the transparent core 202 by a sputtering process or a spin-coating process and then patterned according to the shapes of the optical waveguide 216.

In an example, a thermal ion exchange process is implemented. First, a molten salt source 336 is disposed in the cavity 218. The molten salt source 336 may include 50:50 AgNO₃/NaNO₃. Then, the transparent core 202 and the molten salt source 336 are heated to a temperature of at least 400 K, 500 K, or even higher to accelerate the ion exchange. The heating period may be at least 30 minutes, or at least 60 minutes. The thermal ion exchange process can increase the refractive index of the unblocked area 334 by about 0.5. The increase of the refractive index can reach about 5 μm, 10 μm, 15 μm or even deeper into the transparent core 202.

At operation 340, the molten salt source 336 is removed from the cavity 218. The cavity 218 may be further prepared, such as by etching or polishing, for receiving other devices. As the area 342 surrounding the unblocked area 334 has a lower refractive index than the unexposed area 334, the unblocked area 334 can function as an optical waveguide.

At operation 350, an optical source 222 and a PIC 224 are positioned in the cavity 218. An adhesion film 230 may be used to mount the optical source 222 to the cavity 218. The PIC 224 is coupled with the optical waveguide 216. The PIC 224 and the optical source 222 function as solid state devices and can be made in any suitable semiconductor process. In an embodiment, the heights H′ of PIC 224 and the optical source 222 are about the same as the depth of the cavity 218.

At operation 360, the dielectric material 232 fills empty spaces in the cavity 218 to secure the PIC 224 and the optical source 222 in the cavity 218. In an embodiment, different dielectric materials may be used to fill the cavity 218 and to form the distribution layer 204. Then, a planarization process, such as grinding, milling, or polishing, may be implemented to make the PIC 224 and the laser emitter 22 to be co-planar with the cavity 218. Then, the redistribution layer 204, the top dielectric layer 206, and the bottom dielectric layer 208 are added to the transparent core 202. In an embodiment, a redistribution layer may be disposed between the transparent core 202 and the bottom dielectric layer 208 and may be similarly configured as the redistribution layer 204. In addition, electric vias 362 under the PIC 224 coupled with electric vias 364 in the PIC 224 may be further formed in the transparent core 202.

FIG. 4 illustrates a process 400 for making an interposer having integrated optical devices, according to an embodiment of the present disclosure. Comparing to the process 300, the process 400 may include the same operations 310, 320, 340, 350, and 360, but has a different operation for increasing the refractive index of the transparent core 202. At operation 430, a laser writing method is implemented to form the optical waveguide 216. The mask layer 332 is optional in operation 430 as the laser writing method can focus a laser along a path of the optical waveguide 216 and would not impact other areas. As shown in FIG. 4, a laser 432 focuses a high intensity laser on the transparent core 202 to change the refractive index underneath the tip. For example, a laser system that delivers 150 fs pulses at 775 nm with a 1-KHz repetition rate can be used. A laser system that delivers 120-fs pulses at 790 nm with a repetition rate of 238 KHz can also be used.

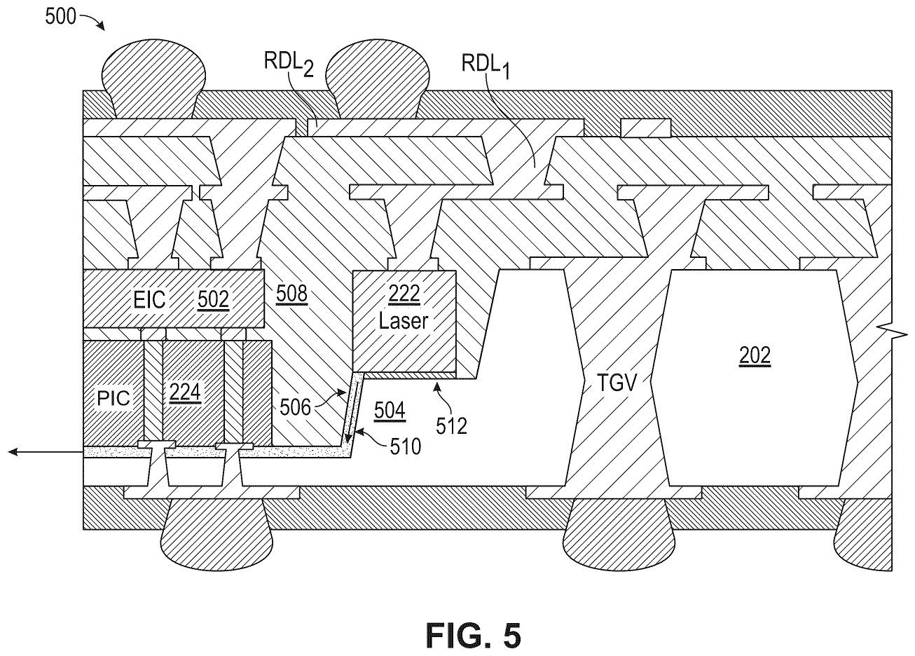

FIG. 5 illustrates a schematic partial cross-sectional view of an interposer, according to an embodiment of the present disclosure. In certain instances, an IC chip 502 may be stacked on top of the PIC 224, forming a taller profile of the stacked device. As a result, a thicker transparent core 202 is used to have a deeper cavity 508 for containing the stacked EIC 502 and the PIC 224. For example, the transparent core may be increase to about 500 μm thick. As the optical source 222 may still be about 300 μm high, the optical source 222 may be disposed on a pedestal 504 formed in the transparent core 202 so that the IC chip 502 and the optical source 222 can be co-planar with the cavity 508. In an embodiment, the optical source 222 is secured to the pedestal 504 by an adhesion film 512. An optical waveguide 506 is formed along a side surface 510 of the pedestal 504 and couples to the bottom surface of the optical source 222. In an embodiment, the side surface 510 is slanted.

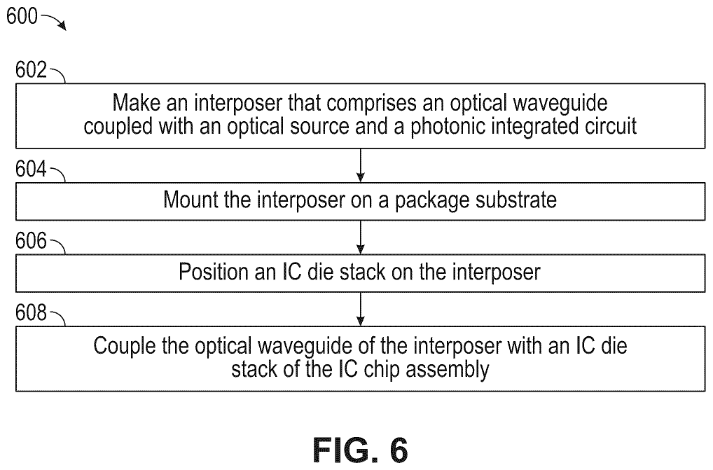

FIG. 6 illustrates a method 600 for making an IC chip assembly, according to an embodiment. At operation 602, an interposer having integrated optical devices is formed. Forming the interposer includes forming a cavity within a transparent core, forming a through via in the transparent core, forming the optical waveguide within the cavity, disposing the optical source within the cavity, and disposing the photonic integrated circuit within the cavity. At operation 604, the interposer is mounted on a package substrate. At operation 606, an IC die stack is positioned on the interposer. At operation 606, the optical waveguide of the interposer is coupled with an IC die stack of the IC chip assembly.

Although operations of the method 600 are described in order, such operations may be configured to operate in alternate orders. In other words, any order or order of operations set forth in the method 600 inherently does not imply a requirement that the operations be performed in that order. The operations of the method may actually be performed in any order. Further, some operations may be performed concurrently. For example, the operation 602 may be followed by the operation 606, then the operation 608, then the operation 604.

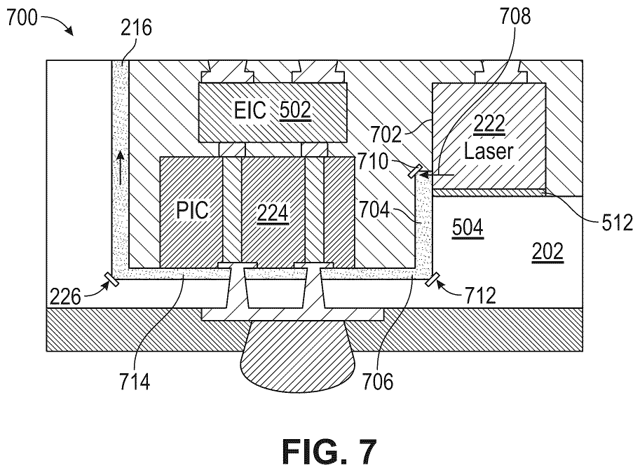

FIG. 7 illustrates a schematic partial cross-sectional view of an interposer 700, according to an embodiment of the present disclosure. The interposer 700 is similarly configured as the interposer 500 as shown in FIG. 5. Differently from FIG. 5, the interposer 700 has an optical waveguide 216 that is coupled with the optical source 222 via a side surface 702 of the optical source 222. The optical waveguide 216 has a vertical segment 704 that couples with the side surface 702 at one end and couples with a horizontal segment 706 at another end. The optical source 222 in FIG. 7 is configured to emit an optical signal 708, such as a laser, through the side surface 702. The vertical segment 704 receives and transmits the optical signal 708 toward the horizontal segment 706. In an embodiment, the vertical segment 704 includes a first mirror 710 disposed adjacent to the side surface 702 and a second mirror 712 disposed between the vertical segment 704 and the horizontal segment 706. The mirrors 710, 712 and 226 may form an angle of about 45 degrees or about 135 degrees with regard to a horizontal surface 714 of the transparent core 202.

While the foregoing is directed to embodiments of the present invention, other and further embodiments of the invention may be devised without departing from the basic scope thereof, and the scope thereof is determined by the claims that follow.

What is claimed is:

1. An interposer comprising:
a transparent core comprising a cavity and an optical waveguide formed in a surface of the cavity;
an optical source disposed within the cavity and coupled with the optical waveguide;
a photonic integrated circuit disposed within the cavity and coupled with the optical waveguide, the photonic integrated circuit, the optical source, and the transparent core being co-planar to each other; and a redistribution layer disposed on the transparent core and comprising metal traces coupled with the optical source.

2. The interposer of claim 1, wherein the optical waveguide includes a vertical segment and a horizontal segment.

3. The interposer of claim 2, wherein the optical waveguide is formed on the surface of the cavity.

4. The interposer of claim 3, wherein the optical waveguide has a refractive index ranging between about 1.4 and about 2.4.

5. The interposer of claim 3, wherein the optical waveguide has a thickness ranging between about 5 μm and about 15 μm.

6. The interposer of the claim 3, wherein the optical waveguide couples to a bottom surface of the optical source.

7. The interposer of claim 1, further comprising a lens coupled with the optical waveguide.

8. The interposer of claim 1, further comprising an adhesion film securing the optical source to the surface of the cavity.

9. The interposer of claim 1, wherein the redistribution layer comprises a heat sink coupled with the optical source.

10. The interposer of claim 9, wherein the heat sink comprises a plurality of vias and pads.

11. The interposer of claim 1, further comprising a first via passing through the transparent core.

12. The interposer of claim 11, wherein the first via is coupled with a second via disposed in the redistribution layer.

13. The interposer of claim 11, wherein the first via is coupled with a third via disposed in the photonic integrated circuit.

14. A chip assembly comprising:
an integrated circuit (IC) die stack comprising a plurality of IC dies;
an interposer disposed under the IC die stack and comprising a transparent core; and
a package substrate disposed under the interposer, the interposer coupling the IC die stack with the package substrate,
wherein the transparent core comprises:
a cavity and an optical waveguide formed in a surface of the cavity;
an optical source disposed within the cavity and coupled with the optical waveguide;
a photonic integrated circuit disposed within the cavity and coupled with the optical waveguide, the photonic integrated circuit, the optical source, and the transparent core being co-planar to each other; and
a redistribution layer disposed on the transparent core and comprising metal traces coupled with the optical source.

15. The chip assembly of claim 14, wherein the optical waveguide includes a vertical segment and a horizontal segment and flushes with the surface of the cavity.

16. The chip assembly of claim 15, wherein the optical waveguide has a refractive index ranging between about 1.4 and about 2.4 and has a thickness ranging between about 5 μm and about 15 μm.

17. The chip assembly of claim 14, further comprising a lens coupled with the optical waveguide.

18. The chip assembly of claim 17, wherein the interposer comprises an adhesion film securing the optical source to a surface of the cavity.

19. The chip assembly of claim 14, further comprising a first via passing through the transparent core, and the via is coupled with a second via disposed in the redistribution layer.

20. A method for making an integrated chip (IC) chip assembly, the method comprising:
forming an interposer that comprises an optical waveguide coupled with an optical source and a photonic integrated circuit, wherein forming the interposer comprises:
forming a cavity within a transparent core;
forming a through via in the transparent core;
forming the optical waveguide within the cavity;
disposing the optical source within the cavity; and
disposing the photonic integrated circuit within the cavity;
mounting the interposer on a package substrate;
positioning an IC die stack on the interposer; and
coupling the optical waveguide of the interposer with an IC die stack of the IC chip assembly.
